(19) United States
(12) Patent Application Publication
(10) Pub. No.: US 2025/0121766 A1
(43) Pub. Date: Apr. 17, 2025

(54) OPTICAL MODULE COMPRISING A CAMERA AND AN OPTICAL DEFLECTION ELEMENT

(71) Applicant: VALEO VISION, Bobigny (FR)

(72) Inventors: Christophe GRARD, Bobigny (FR); Pierre RENAUD, Bobigny (FR); Gregory PLANCHE, Bobigny (FR); Christian TEXIER, Bobigny (FR)

(73) Assignee: VALEO VISION, Bobigny (FR)

(21) Appl. No.: 18/691,752

(22) PCT Filed: Sep. 12, 2022
(86) PCT No.: PCT/EP2022/075242

§ 371 Date: Mar. 13, 2024

(30) Foreign Application Priority Data
Sep. 14, 2021 (FR) FR2109648

(51) Int. Cl. B60Q 1/00; B60Q 1/04; B60Q 1/34; B60Q 9/00; G02B 5/00

(52) U.S. Cl. CPC B60Q 1/0023; B60Q 9/008; G02B 5/003; B60Q 1/04; B60Q 1/34

(57) ABSTRACT

The invention relates to an optical module for a vehicle, which includes a camera with a set of optical lenses, a housing to receive the camera, a protective lens facing the camera, at least one light source to emit light rays to illuminate the protective lens and being next to the housing of the camera. The optical module also includes at least one optical deflection element to deflect the multiple reflections on the protective lens of all or part of the light rays emitted by the at least one light source so as to prevent the light rays from returning to the set of optical lenses of the camera.

### TECHNICAL FIELD

The present invention relates to an optical module for a vehicle. It is particularly, but non-limitingly, applicable to motor vehicles.

### BACKGROUND OF THE INVENTION

As shown in FIG. 1, an example, known to those skilled in the art, of an optical module 6 for a vehicle comprises:
a camera 60 comprising a set of optical lenses 600,
a housing 61 configured to accept said camera 60,
a protective lens 62, placed facing said camera 60,
at least one light source 63 configured to emit light rays R1 for illuminating said protective lens 62, said at least one light source 63 being positioned next to the housing 61 of said camera 60.

The camera 60 is used to monitor the external surroundings of the vehicle and is used for driver assist functions such as assisting with parking, assisting with overtaking; and safety functions such as automatic braking in the event of detection of pedestrians, or bicycles crossing in front of said vehicle. It generates images of the external surroundings of the vehicle, which images in nonlimiting embodiments:
assist the driver of the vehicle with driving: the driver can view the images from the camera 60 on the on-board screen, and/or
are used by an assistance system to assist with driving.

One disadvantage of this prior art is that light rays R1 from said at least one light source 63 are reflected off the interior surface 62.2 of the protective lens 62, thus creating primary reflections r1 as shown in FIG. 1. These primary reflections r1 are reflections of order 1. Some of these primary reflections r1 return to the set of lenses 600, as illustrated in FIG. 1. Other primary reflections r1 are in turn reflected off the interior surface 62.2 of said protective lens 62 and thus create secondary reflections r2, some of which are likewise returned to the set of lenses 600 as shown in FIG. 1, and so on. This set of reflections referred to as multiple reflections, which amongst others include the primary reflections r1 and the secondary reflections r2 inside the set of optical lenses 600 will therefore disturb the field of view FoV of the camera 60.

The driver will see parasitic light in the images generated by the camera 60, and this will be visually bothersome for said driver looking at the images from the camera 60 on the on-board screen. The driver-assist functions will therefore be less effective. Moreover, these multiple reflections will disturb the generation of images by the camera 60 and so the safety functions will also be less effective.

### SUMMARY OF THE INVENTION

In this context, the present invention aims to provide an optical module that allows the aforementioned drawback to be overcome.

To this end, the invention proposes an optical module for a vehicle, said optical module comprising:
a camera comprising a set of optical lenses, and having a field of view,
a housing configured to accept said camera,
a protective lens positioned facing said camera, said protective lens having an external refracting surface and an internal refracting surface,
at least one light source configured to emit light rays for illuminating said protective lens, said at least one light source being positioned next to the housing of said camera, characterized in that said optical module further comprises at least one optical deflection element configured to deflect the multiple reflections, off said protective lens, of all or some of the light rays emitted by said at least one light source so as to prevent them from returning to the set of optical lenses of said camera.

Thus, as will be seen in detail hereinafter, thanks to the optical deflection element, the reflections of the light rays from said at least one light source will not return to the set of optical lenses of the camera. Therefore they will not interfere with the field of view of the camera. There will therefore be no parasitic light in the images from the camera.

According to non-limiting embodiments, said optical module may furthermore comprise one or more of the following additional features, implemented alone or in any technically possible combination.

According to one nonlimiting embodiment, said at least one optical deflection element is a groove originating on the internal refracting surface of said protective lens.

According to one nonlimiting embodiment, said groove has an internal surface covered with black paint.

According to one non-limiting embodiment, said groove comprises prisms.

According to one nonlimiting embodiment, said external refracting surface of said protective lens has a curved surface positioned facing said at least one light source.

According to one nonlimiting embodiment, said at least one optical deflection element is made from a light-absorbing material.

According to one nonlimiting embodiment, said at least one optical deflection element is positioned adjacent to said internal refracting surface of said protective lens and extends along said internal refracting surface.

According to one nonlimiting embodiment, said at least one optical deflection element is formed by prisms situated on the internal refracting surface of said protective lens.

According to one nonlimiting embodiment, said at least one optical deflection element is a cavity on the internal refracting surface of said protective lens and positioned facing the field of view of the camera.

According to one nonlimiting embodiment, all or part of said at least one optical deflection element is positioned on the optical path of said multiple reflections.

According to one nonlimiting embodiment, said protective lens is a logo of said vehicle or an exit outer lens of a front headlight of said vehicle or a front-end grille of said vehicle or an exit outer lens of a tail light, or a turn signal repeater.

According to one nonlimiting embodiment, said groove is positioned on the optical path of said multiple reflections.

According to one nonlimiting embodiment, said groove is configured to also deflect certain light rays.

According to one nonlimiting embodiment, said groove is positioned on the optical path of certain light rays.

According to one nonlimiting embodiment, said groove is positioned outside of the field of view of said camera.

According to one nonlimiting embodiment, said groove is positioned outside of the field of view of said at least one light source.

According to one nonlimiting embodiment, the prisms are situated on the internal surface of the groove.

According to one nonlimiting embodiment, said light-absorbing material is positioned inside or outside of said protective lens.

According to one nonlimiting embodiment, said light-absorbing material is positioned outside of the field of view of said camera.

According to one nonlimiting embodiment, said light-absorbing material is positioned outside of the field of view of said at least one light source.

According to one nonlimiting embodiment, the prisms point towards the inside of the protective lens.

According to one nonlimiting embodiment, the prisms point towards the outside of the protective lens.

### BRIEF DESCRIPTION OF DRAWINGS

The invention and the different applications thereof can be better understood from reading the description below and studying the accompanying figures:

FIG. 1 is a schematic view, from above, of an optical module for a vehicle, said optical module comprising a camera, a housing for said camera, a protective lens and at least one light source, according to the prior art,

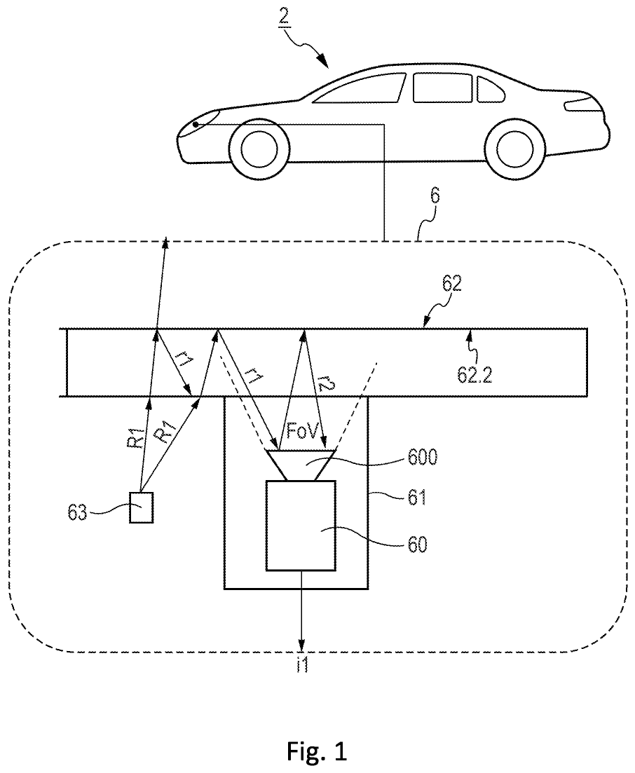

FIG. 2 is a schematic view, from above, of an optical module for a vehicle, said optical module comprising a camera, a housing for said camera, a protective lens, at least one light source, and at least one optical deflection element, according to a first nonlimiting embodiment of the invention,

FIG. 3 is a view zooming in on part of said optical module of FIG. 2, according to one non-limiting embodiment,

FIG. 4 is a schematic view, from above, of an optical module of FIG. 2, according to a first embodiment variant of the first nonlimiting embodiment,

FIG. 5 is a schematic view, from above, of an optical module of FIG. 2, according to a second embodiment variant of the first nonlimiting embodiment,

FIG. 6 is a schematic view, from above, of an optical module of FIG. 2, according to a third embodiment variant of the first nonlimiting embodiment,

FIG. 7 is a schematic view, from above, of an optical module for a vehicle, said optical module comprising a camera, a housing for said camera, a protective lens, at least one light source, and at least one optical deflection element, according to a second nonlimiting embodiment of the invention,

FIG. 8 is a schematic view, from above, of an optical module for a vehicle, said optical module comprising a camera, a housing for said camera, a protective lens, at least one light source, and at least one optical deflection element, according to a third nonlimiting embodiment of the invention,

FIG. 9 is a schematic view, from above, of an optical module for a vehicle, said optical module comprising a camera, a housing for said camera, a protective lens, at least one light source, and at least one optical deflection element, according to a third nonlimiting embodiment of the invention.

### DETAILED DESCRIPTION OF THE INVENTION

Elements that are identical in terms of structure or function and that appear in various figures are designated by the same references, unless indicated otherwise.

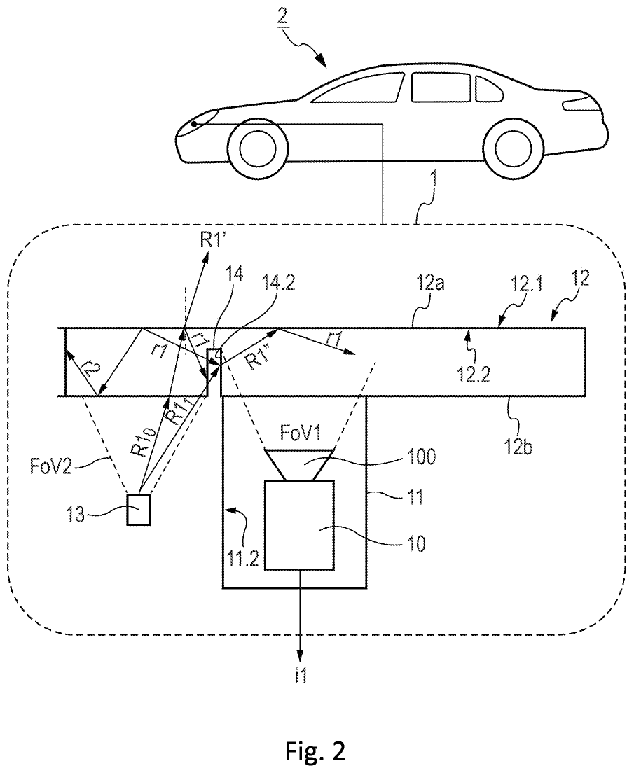

The optical module 1 for a vehicle 2 according to the invention is described with reference to FIGS. 2 to 9. In one nonlimiting embodiment, the vehicle 2 is a motor vehicle. “Motor vehicle” means any type of motorized vehicle. This embodiment will be considered, by way of nonlimiting example, in the remainder of the description. Throughout the remainder of the description, the vehicle 2 is thus also called the motor vehicle 2.

As shown in FIGS. 2 to 9, the optical module 1 for a motor vehicle 2 comprises:
a camera 10,
housing 11,
a protective lens 12,
at least one light source 13, and
at least one optical deflection element 14.

The elements of the optical module 1 are described in detail below.

The camera 10 comprises a set of optical lenses 100. Said set of optical lenses 100 includes one or more optical lenses. The camera 10 has a field-of-view FoV1 depicted in dashed lines in the figures. The camera 10 generates images i1 of the external surroundings of the motor vehicle 2. In other words, it generates images i1 relating to a scene in the external surroundings. The camera 10 thus detects moving objects such as other vehicles, pedestrians, bicycles, etc., or static objects such as sidewalks, road markings, buildings, trees, etc. In a first nonlimiting embodiment, the camera 10 is used for driver assistance functions. The images i1 are displayed on the instrument panel of the motor vehicle 2 and allow the driver of the motor vehicle 2 to execute maneuvers for parking said motor vehicle 2, or for overtaking another vehicle, by way of nonlimiting examples. In another non-limiting example, the images i1 allow the driver to see at an intersection the vehicles which may come from the right and the left, in order to determine whether or not this driver can cross the intersection safely. In another non-limiting example, the images i1 are images from a reversing camera. They thus make it possible to see pedestrians who are behind the motor vehicle 2 and thus allow the driver to carry out a reversing maneuver in complete safety without running over pedestrians. In a second nonlimiting embodiment, the camera 10 is used for safety functions such as automatic braking in instances in which the camera 10 has detected pedestrians or bicycles crossing in front of the motor vehicle 2, in one nonlimiting example. In a third nonlimiting embodiment, the camera 10 is used for autonomous driving functions such as an automatic parking function.

Of course, the three nonlimiting embodiments illustrating the use of the camera 10 may be combined.

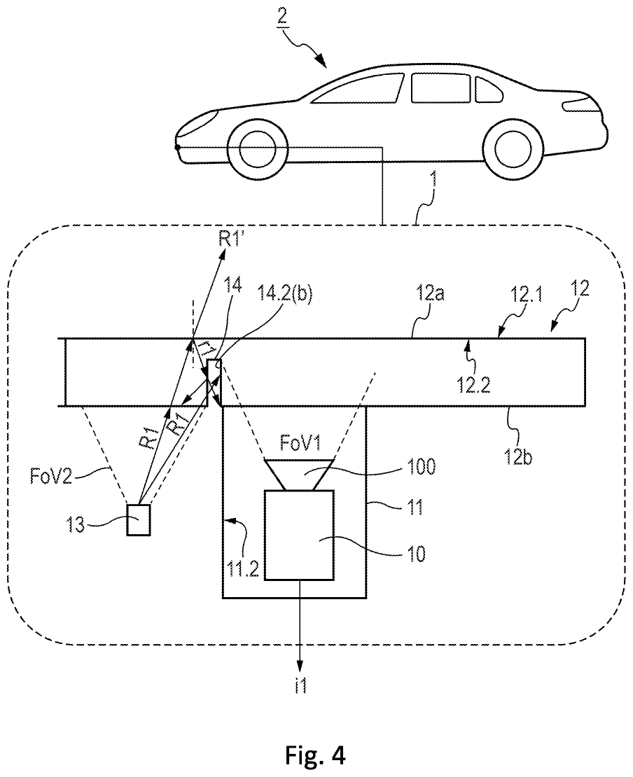

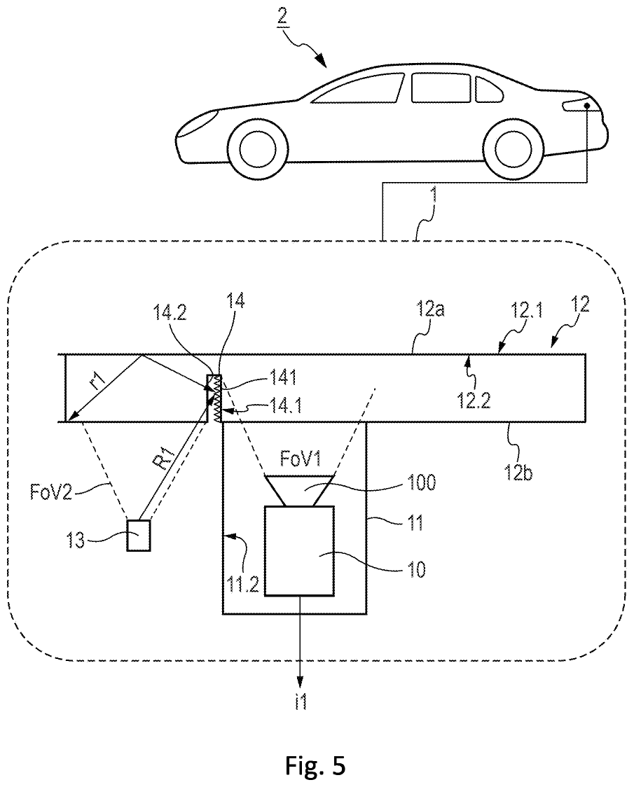

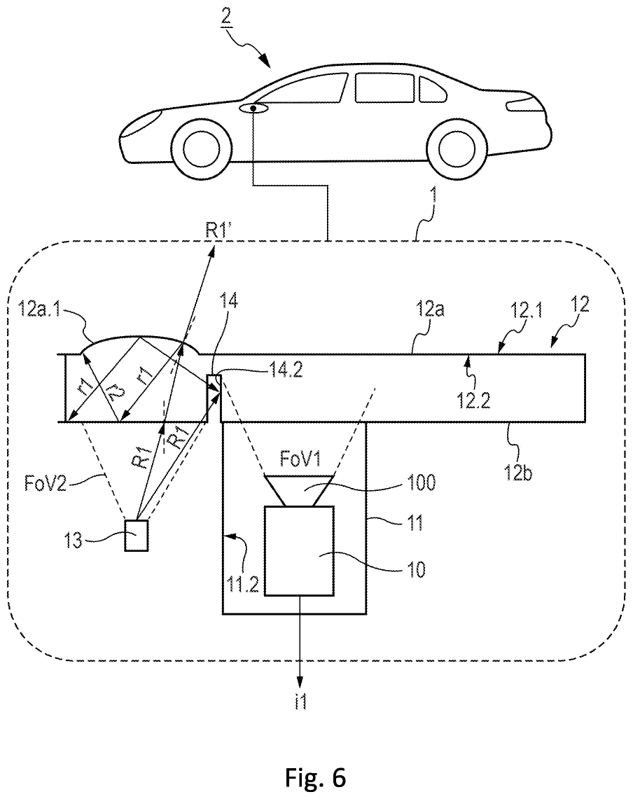

In one non-limiting embodiment, the camera 10 is a wide-angle camera. In one non-limiting example, the camera 10 has a total horizontal angle of 170° relative to the vehicle axis Ax. In non-limiting embodiments, the camera 10 is placed at the front, at the rear or on one side of said motor vehicle 2. In non-limiting embodiments, the camera 10 is positioned:
at the site of an illuminated logo, as illustrated in FIG. 4, or
in a front headlight, as illustrated in FIG. 2, or
behind an illuminated front end grille, as illustrated in FIG. 4, or
in a tail light, as illustrated in FIG. 5, or
in a turn signal repeater in an external side mirror, as illustrated in FIG. 6.

The housing 11 is configured to receive the camera 10. In one non-limiting embodiment, the interior surface 11.2 of the housing 11 is black and non-reflective. In order to be non-reflective, it is, in one non-limiting embodiment, covered with a matte paint. This makes it possible to conceal the camera 10 from outside the motor vehicle 2. Thus, an observer outside the motor vehicle 2 will not see the camera 10 if they look at the optical module 1.

The protective lens 12, also known as the outer lens, is positioned facing the camera 10. It is configured to conceal the camera 10 from outside the motor vehicle 2. The camera 10 is thus invisible to an observer outside the motor vehicle 2 looking at the optical module 1. The protective lens 12 is thus opaque. The protective lens 12 has an internal surface 12.2 facing toward the camera 10 and an external surface 12.1, opposite the internal surface 12.2, facing toward the outside of the motor vehicle 2. In one non-limiting embodiment, the protective lens 12 closes off the housing 11. Said protective lens 12 has an external refracting surface 12a and an internal refracting surface 12b. The internal refracting surface 12b faces toward the camera 10. The external refracting surface 12a faces toward the outside of the motor vehicle 2. As illustrated in the figures, part of the light rays R1 will reflect off the internal surface 12.2 of the protective lens 12 to create multiple reflections r, otherwise known as internal reflections r or reflections r including order-1 reflections, otherwise referred to as reflections r1, and order-2 reflections, otherwise referred to as reflections r2. One part (referenced R1′) of the light rays R1 will pass through the protective lens 12 and re-emerge to outside the motor vehicle 2.

When the camera 10 is sited:
at an illuminated logo, the protective lens 12 is the logo itself,
in a front headlamp, the protective lens 12 is the exit outer lens of the front headlight,
behind an illuminated front end grille, the protective lens 12 is the front end grille.

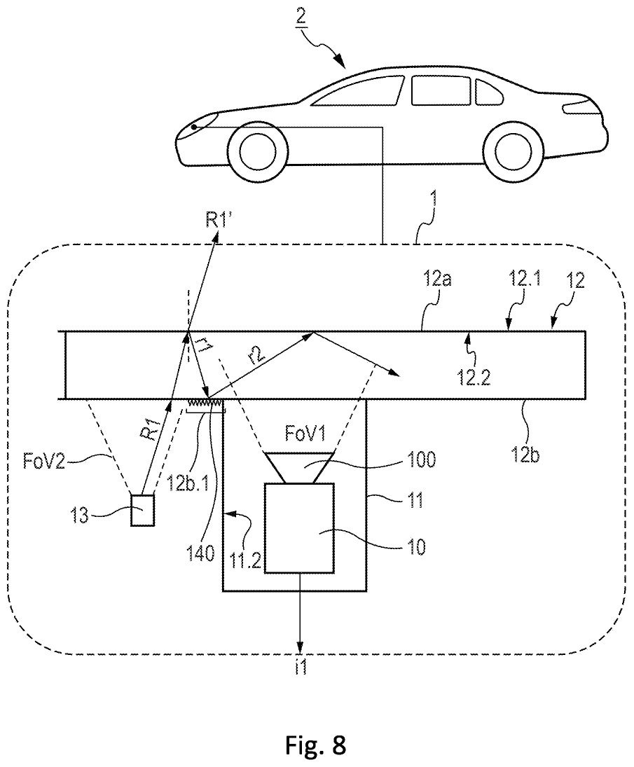

Said at least one light source 13, also referred to as light source 13, is configured to illuminate the protective lens 12. Thus, in some nonlimiting embodiments, it illuminates either a logo in order to create an illuminated logo, or a front-end grille in order to create an illuminated front-end grille, or the exit outer lens of a front headlight when it is the light source of the front headlight. For this purpose, it emits light rays R1 which arrive at the protective lens 12 in order to illuminate same. Said light source 13 is arranged next to the camera 10. In one nonlimiting embodiment, the optical module 1 comprises a plurality of light sources 12 as illustrated in FIG. 8 where it comprises two light sources 12. Said at least one light source 13 has a field of view FoV2.

In one non-limiting embodiment, said at least one light source 13 is a semiconductor light source. In one non-limiting embodiment, the semiconductor light source forms part of a light-emitting diode. A light-emitting diode is understood to mean any type of light-emitting diodes, whether in non-limiting examples of LEDs, OLEDs (Organic LEDs), AMOLEDs (Active-Matrix-Organic LED), or even FOLEDs (Flexible OLEDs).

In FIGS. 2 to 7, the light source 13 is illustrated to the left of the camera 10 in a nonlimiting example. It is positioned behind the protective lens 12 from the point of view of an observer stationed outside the motor vehicle 2. In FIG. 8, the two light sources 13 are illustrated to the left and to the right of the camera 10 in a nonlimiting example. They are positioned behind the protective lens 12 from the point of view of an observer stationed outside the motor vehicle 2.

In the remainder of the description, the nonlimiting embodiment with just a single light source is considered by way of nonlimiting example.

In one nonlimiting embodiment, the optical module 1 comprises a single optical deflection element 14 as illustrated in FIGS. 2 to 8. In the remainder of the description, the nonlimiting embodiment with a single optical deflection element 14 is considered by way of nonlimiting example.

The optical deflection element 14 is configured to deflect the multiple reflections r, off said protective lens 12, of all or some of the light rays R1 emitted by said at least one light source 13 and some of said light rays R1 so as to prevent them from returning to the set of optical lenses 100 of said camera 10 and therefore prevent them from disturbing the field of view FoV1 of same. These light rays R are those that may reflect off the internal surface 12.2 of the protective lens 12 and may return to the set of optical lenses 100 of the camera 10 through multiple reflection r. In one nonlimiting embodiment, the optical deflection element 14 is configured to deflect the multiple reflections r, off said protective lens 12, of all the light rays R1 from said at least one light source 13 and some of said light rays R1 so as to prevent them from returning to the set of optical lenses 100 of said camera 10.

The optical deflection element 14 thus prevents the multiple reflections r of some light rays R1, otherwise known as parasitic reflections r, from disturbing the field of view FoV1 of the camera 10. The multiple reflections r comprise order-1 reflections, order-2 reflections and any other reflections of order n, where n is an integer. It will be recalled that order-1 reflections are those which originate from the light rays R1 and are reflected off the internal surface 12.2 of the protective lens 12. Order-2 reflections are those which originate from the order-1 reflections and are reflected off the internal surface 12.2 of the protective lens 12. For the sake of simplification, only the reflections r1 and r2 have been illustrated in the figures.

As will be seen hereinafter, the optical deflection element 14 is configured:
either to deflect said light rays R1 and their multiple reflections r so that said multiple reflections r do not return to the set of optical lenses 100 of the camera 10 and thus do not impair the field of view FoV1 of the camera 10,
or to absorb said light rays R1 and their multiple reflections r so that said multiple reflections r do not return to the set of optical lenses 100 of the camera 10 and thus do not impair the field of view FoV1 of the camera 10.

Various nonlimiting embodiments of the optical deflection element are described in detail hereinafter.

In a first nonlimiting embodiment, illustrated in FIG. 2, the optical deflection element 14 is a groove originating on the internal refracting surface 12b of the protective lens 12. The groove 14 is positioned outside of the field of view FoV1 of the camera 10 and outside of the field of view FoV2 of the light source 13. The groove 14 is situated on the optical path of the multiple reflections r of all or some of the light rays R1 and on the optical path of some light rays R1 emitted by the light source 13. In a nonlimiting embodiment variant, the groove 14 is situated on the optical path of the multiple reflections r of all of the light rays R1 and on the optical path of some light rays R1 emitted by the light source 13.

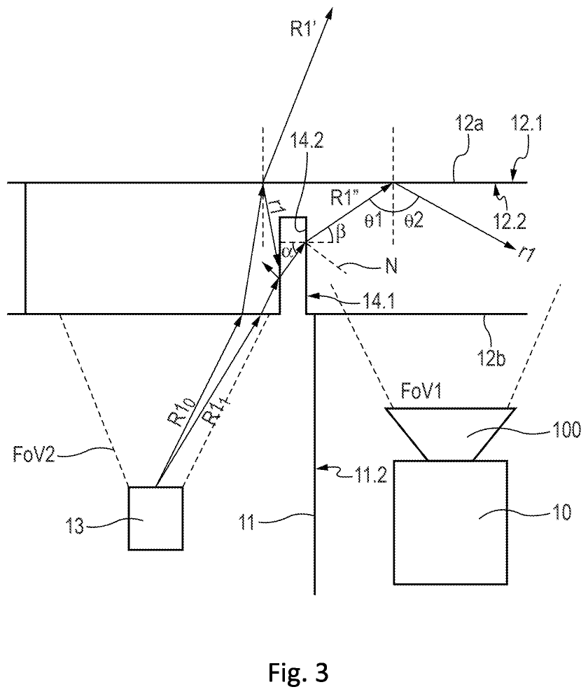

As can be seen in FIG. 2, and the zoomed-in view of FIG. 3:
(a) some light rays R10 emitted by the light source 13 will be reflected off the internal surface 12.2 of the protective lens 12 in order to yield order-1 reflections which will arrive at the groove 14 and be reflected off same to the left,
(b) some light rays R11 emitted by the light source 13 will:
(i) be reflected off the external surface 14.1 of the groove 14 and be deflected to the left and be reflected again off the internal surface 12.2 on the external refracting surface side 12a of the protective lens 12 (these are the reflections r1), and then on the internal refracting surface side 12b of the protective lens 12 (these are the reflections r2) etc. The reflections r1, r2 etc. do not return to the field of view FoV1 of the camera 10, and
(ii) be reflected off the internal surface 14.2 of the groove 14 and be deflected to the left and be reflected again off the internal surface 12.2 on the external refracting surface side 12a of the protective lens 12 (these are the reflections r1), and then on the internal refracting surface side 12b of the protective lens 12 (these are the reflections r2) etc. The reflections r1, r2 etc. do not return to the field of view FoV1 of the camera 10, and
(iii) pass directly across the groove 14, in this instance to the right, and re-emerge from the groove 14—this is the transmitted light ray R1″—such that the said transmitted light ray R1″ will not reach the set of optical lenses 100 of the camera 10.

As illustrated in the zoomed-in view of FIG. 3, it may be seen that the transmitted ray R1″ has an exit angle of incidence β that is smaller than an entry angle α (inside the groove 14). The exit angle of incidence β is defined with respect to the normal to the groove 14 along the longitudinal axis thereof.

The transmitted ray R1″ re-emerges from the groove 14 with the exit angle of incidence β such that it will not reach the set of optical lenses 100 of the camera 10. Thanks to the groove 14, the exit angle of incidence β is bent closer to the normal N compared to the light ray R1. Thus, the groove 14 makes it possible to reduce the exit angle of incidence β of the transmitted ray R1.

It will also be noted that because some of the light rays R11 are reflected to the left, the transmitted ray R1″ will be reduced in intensity as will its multiple reflections r off the internal surface 12.2 of the protective lens 12.

As illustrated in the zoomed-in view of FIG. 3, so far as the reflections r1 of the transmitted ray R1″ off the internal surface 12.2 on the external refracting surface side 12a are concerned, the entry angle of incidence of reflection θ1 is equal to the entry angle of incidence of reflection θ2 and greater with the groove 14 than without the groove 14 so that said reflections r1 can indeed be guided in such a way that they do not return to the set of optical lenses 100 of the camera 10. The entry angle of incidence of reflection θ1 and the exit angle of incidence of reflection θ2 are defined with respect to the normal to the external refracting surface 12a.

In a first nonlimiting embodiment variant illustrated in FIG. 4, the groove 14 comprises an internal surface 14.2 that is covered with black paint b. The black paint b makes it possible to stop the light rays R1 that arrive at the groove 14. These are then not reflected off the internal surface 14.2 of the groove 14, unlike in the case of a groove 14 that is transparent for example. In addition, there are no transmitted rays R1″. The black paint b also makes it possible to stop the multiple reflections r originating from other reflections r or from light rays R1 that are reflected off the internal surface 12.2 of the protective lens. In the nonlimiting example illustrated, it may be seen that the black paint b stops the reflections r1 of a light ray R that is reflected off the internal surface 12.2 on the external refracting surface side 12a of the protective lens 12.

In a second non-limiting embodiment variant illustrated in FIG. 5, the groove 14 comprises prisms 141 (illustrated). The prisms 141 deflect the light rays R1 and the reflections r thereof such that they are not directed toward the field of view FoV1 of the camera. The prisms 141 are suitable for directing the light rays R1 in favored directions, which are directions other than those tending toward the camera 10. In the non-limiting example illustrated, the prisms 141 are situated on the internal surface 14.2 of the groove 14.

In a third non-limiting embodiment variant illustrated in FIG. 6, the external refracting surface 12a of the protective lens 12 comprises a curved surface 12a.1 positioned facing the light source 13, notably in the field of view FoV2 thereof. The curved surface 12a.1 is therefore positioned outside of the field of view FoV1 of the camera 10. The curved surface 12a.1 will amplify the deflection phenomenon achieved by the groove 14 so that the light rays R1 and the multiple reflections r already deflected by the groove 14 will be deflected even further away from the camera 10, in this instance to the left. Thanks to the curved surface 12a.1, no light ray R1 or multiple reflection r will be directed to the right toward the camera 10. In one non-limiting embodiment, it is positioned offset from said groove 14 so as to capture the multiple reflections r and the light rays R1 deflected by the groove 14. In the non-limiting example illustrated, the curved surface 12a.1 is offset to the left of the groove 14, namely is not situated facing said groove 14.

It will be noted that the three non-limiting embodiment variants may be considered in isolation or in any combination.

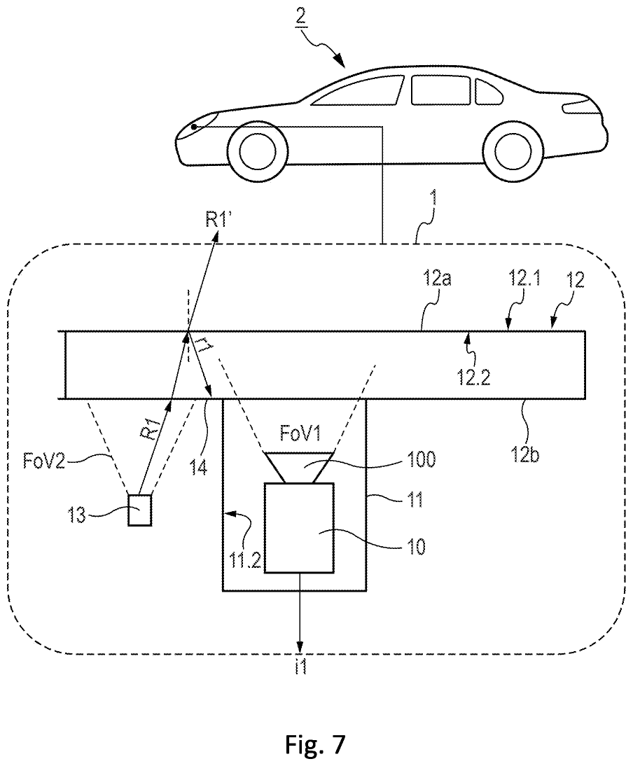

In a second non-limiting embodiment illustrated in FIG. 7, the optical deflection element 14 is made from a light-absorbing material. The deflection element 14 is positioned on the optical path of the multiple reflections r of all or some of the light rays R1 emitted by said at least one light source 10, namely those reflections and those rays at risk of reaching the set of optical lenses 100 of the camera 10. In one non-limiting example, the light-absorbing material is black-tinted polycarbonate with a high linear absorption coefficient. In one non-limiting embodiment variant illustrated in FIG. 7, the optical deflection element 14 is positioned adjacent to the internal refracting surface 12b of the protective lens 12 and extends along said internal refracting surface 12b. In one non-limiting embodiment that has been illustrated, the optical deflection element 14 is situated inside the protective lens 12. The optical deflection element 14 is positioned near the housing 11 of the camera 10 outside the field of view FoV1 of the camera 10 and also outside the field of view FoV2 of the light source 13. As may be seen in the figure, certain light rays R1 which are reflected off the internal surface 12.2 of the protective lens 12 return to the internal refracting surface 12b at the site of the absorbent material 14 and will be absorbed by said absorbent material 14. In one non-limiting embodiment that has not been illustrated, the optical deflection element 14 is situated outside the protective lens 12. It will be noted that the embodiment in which the optical deflection element 14 is situated inside the protective lens 12 is more esthetically appealing than the embodiment in which it is situated on the outside. It will be noted that the embodiment in which the optical deflection element 14 is situated on the outside of the protective lens 12 is easier to manufacture than the embodiment in which it is situated on the inside.

In a third non-limiting embodiment illustrated in FIG. 8, the optical deflection element 14 is formed of prisms 140 (illustrated) situated on the internal refracting surface 12b of the protective lens 12 and notably along said internal refracting surface 12b. Thus, part of the surface 12b.1 of the internal refracting surface 12b comprises said prisms 140. The optical deflection element 14 comprising the prisms 140 is positioned on the optical path of the multiple reflections r, off said protective lens 12, of all or some of the light rays R1 emitted by the light source 10, namely those reflections and those rays at risk of reaching the set of optical lenses 100 of the camera 10. The prisms 140 are positioned outside of the field of view FoV1 of the camera 10. The prisms 140 are also positioned outside of the field of view FoV2 of the light source 13. The prisms 140 are suitable for directing the multiple reflections r (including r1) of the light rays R1 in favored directions, which are directions other than those tending toward the camera 10. In non-limiting embodiments, the prisms 140 point toward the inside of the protective lens 12 (this is not illustrated) or point toward the outside of the protective lens 12, as illustrated in FIG. 8. As can be seen in the figure, the multiple reflections r of the light rays R1 that are reflected off the internal surface 12.2 of the protective lens 12 are deflected by the prisms 140 in a direction other than the direction of the camera 10 and will thus not reflect off the set of optical lenses 100 of the camera 10 and therefore will not disturb the field of view FoV1 thereof. It will be noted that the embodiment in which the optical deflection element 14 comprising the prisms 140 is situated on the outside of the protective lens 12 is easier to manufacture than the embodiment in which it is situated on the inside.

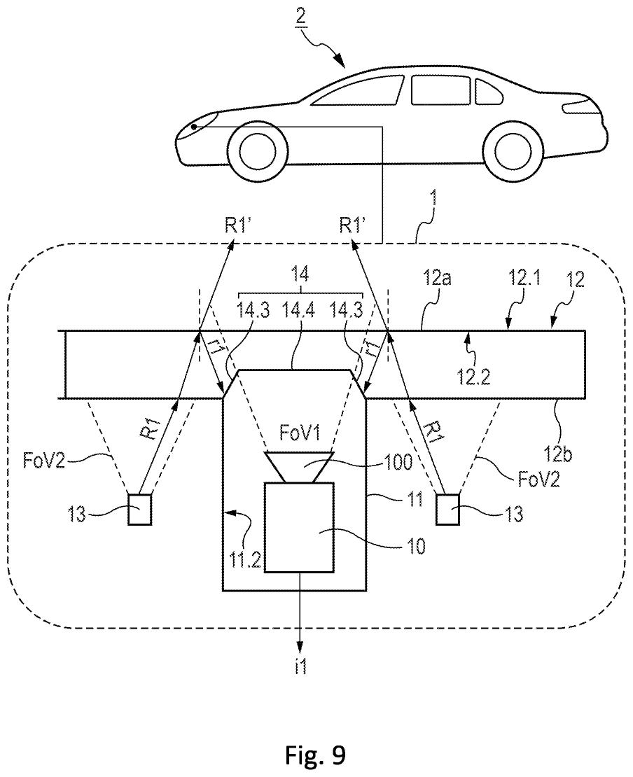

In a fourth nonlimiting embodiment, illustrated in FIG. 9, the optical deflection element 14 is a cavity originating on the internal refracting surface 12b of said protective lens 12 and which is positioned facing the field of view FoV1 of the camera 10.

Part of the cavity 14 is positioned on the optical path of the multiple reflections r, off said protective lens 12, of all or some of the light rays R1 emitted by said at least one light source 10, namely those reflections at risk of returning to disrupt the field of view FoV1 of the camera 10.

The cavity 14 is of trapezoidal or curved shape. In a non-limiting embodiment variant that has been illustrated, the cavity 14 has a bottom 14.4 and two sides 14.3 originating from each end of said bottom 14.4. The part able to deflect the reflections r is made up of one or of both sides 14.3. Of just one side if there is just one single light source 13, or of both sides 14.3 if there are two light sources 13 as there are in the non-limiting example illustrated. For this purpose, each side 14.3 is designed to deflect the multiple reflections r of certain light rays R1 emitted by each light source 13 respectively. As may be seen in the figure, the cavity 14 the multiple reflections r of certain light rays R1 so that these do not reach the camera 10. In the non-limiting example illustrated, only the reflections r1 have been illustrated.

Of course, the description of the invention is not limited to the embodiments described above and to the field described above. Thus, in one non-limiting embodiment, the optical module 1 comprises several optical deflection elements 14 according to any one of the non-limiting embodiments presented or according to any combination of the non-limiting embodiments presented. Thus, in another non-limiting embodiment of the second non-limiting embodiment variant illustrated in FIG. 5, the prisms 141 are situated on the external surface 14.1 of the groove 14 instead of on the internal surface 14.2. Thus, in one non-limiting embodiment, in FIG. 5, the prisms 141 of the groove 14 may be replaced by a graining. Thus, in one non-limiting embodiment, in FIG. 8, the prisms 140 of the optical deflection element 14 may be replaced by graining situated on the internal refracting surface 12b of the protective lens 12.

Thus, the invention described notably has the following advantages:
it makes it possible to reduce considerably, or even eliminate, the multiple reflections r off the set of optical lenses 100, which parasitic reflections originate from said at least one light source 13; the driver of the vehicle 2 no longer sees bothersome light when viewing the images from the camera.

What is claimed is:

1. An optical module for a vehicle, the optical module comprising:
a camera including a set of optical lenses, and having a field of view,
a housing configured to accept the camera,
a protective lens positioned facing the camera, the protective lens having an external refracting surface and an internal refracting surface,
at least one light source configured to emit light rays for illuminating the protective lens, the at least one light source being positioned next to the housing of the camera, and
at least one optical deflection element configured to deflect the multiple reflections, off the protective lens, of all or some of the light rays emitted by the at least one light source so as to prevent them from returning to the set of optical lenses of the camera.

2. The optical module as claimed in claim 1, wherein the at least one optical deflection element is a groove originating on the internal refracting surface of the protective lens.

3. The optical module as claimed in claim 2, wherein the groove has an internal surface covered with black paint.

4. The optical module as claimed in claim 2, wherein the groove includes prisms.

5. The optical module as claimed in claim 1, wherein the external refracting surface of the protective lens has a curved surface positioned facing the at least one light source.

6. The optical module as claimed in claim 1, wherein the at least one optical deflection element is made from a light-absorbing material.

7. The optical module as claimed in claim 6, wherein the at least one optical deflection element is positioned adjacent to the internal refracting surface of the protective lens and extends along the internal refracting surface.

8. The optical module as claimed in claim 1, wherein the at least one optical deflection element is formed by prisms situated on the internal refracting surface of the protective lens.

9. The optical module as claimed in claim 1, wherein the at least one optical deflection element is a cavity on the internal refracting surface of the protective lens and positioned facing the field of view of the camera.

10. The optical module as claimed in claim 1, wherein all or part of the at least one optical deflection element is positioned on the optical path of the multiple reflections.

11. The optical module as claimed in claim 1, wherein the optical module includes a plurality of optical deflection elements.

12. The optical module as claimed in claim 1, wherein the protective lens is a logo of the vehicle or an exit outer lens of a front headlight of the vehicle or a front-end grille of the vehicle or an exit outer lens of a rear light, or a turn signal repeater.
